(19) United States
(12) Patent Application Publication
(10) Pub. No.: US 2008/0241813 A1
(43) Pub. Date: Oct. 2, 2008

(54) Method and apparatus for teaching the installation of vehicle protective coverings

(76) Inventor: Stephen Costa, La Verne, CA (US)

Correspondence Address: JAMES E. BRUNTON, ESQ., P. O. BOX 29000, GLENDALE, CA, 91209, US

(21) Appl. No.: 11/729,519

(22) Filed: Mar. 28, 2007

(51) Int. Cl. G09C 1/00

(52) U.S. Cl. 434/373

(57) ABSTRACT

A method and apparatus for teaching installers the proper technique for adhesively bonding a protective covering to an exterior portion of a vehicle. The apparatus of the invention includes a training cover constructed from a static-cling material and having the shape of the protective covering that is to be adhesively bonded to the exterior portion of the vehicle and one that can be easily removed from the automobile surface by applying a pulling force in a direction away from the vehicle.

### BACKGROUND OF THE INVENTION

1. Field of the Invention

The present invention relates generally to protective coverings that are applied to selected exterior portions of a vehicle. More particularly the invention concerns a method and apparatus for teaching installers the proper technique for affixing a protective covering to an exterior portion of a vehicle.

2. Discussion of the Prior Art

In the past it has been common practice to apply various types of protective coverings to selected exterior portions of vehicles such as automobiles and trucks. While various types of protective coverings have been suggested a common material that has been used for such purposes comprises a polyvinyl chloride in sheet form. Typically, the polyvinyl chloride sheet is cut into a number of different segments, each having a shape that substantially corresponds to the shape of the area being protected. For example, the segments may comprise a hood segment that has a shape substantially matching the hood area of the vehicle to be covered. Alternatively the segments may comprise bumper segments that have shapes substantially matching the shape of the bumper of the vehicle to be covered. After the various segments have been cut to the proper size, the segments are adhesively bonded to the appropriate vehicle surface through the use of a number of different types of adhesives, including pressure sensitive adhesives, such as adhesives sold by the Locite Corporation of Merington, Conn.

Proper installation of prior art protective coverings, such as those comprising polyvinyl chloride segments, typically require installation by experienced, well-trained installers. Because these prior art protective coverings are quite expensive, it is essential that the coverings be properly initially installed. If following an initial installation, the coverings are not smooth and free of bubbles, wrinkles and creases; the defective covering must be removed and discarded thereby resulting in substantial financial loss to the installer. It is this problem that the present invention addresses by providing a novel training method and apparatus that enables the installer to be successfully trained without risking the loss of expensive protective coverings. More particularly, in carrying out the method of the present invention, static-cling training segments carrying instructional indicia are used to train the installer in the proper techniques for successfully installing the more expensive, adhesively affixed protective coverings.

### SUMMARY OF THE INVENTION

It is an object of the present invention to provide a novel method and apparatus for teaching installers the proper technique for adhesively bonding a protective covering to an exterior portion of a vehicle.

Another object of the invention is to provide an apparatus of the aforementioned character that comprises a training cover having the shape of the protective covering that is to be adhesively bonded to the exterior portion of the vehicle and one that can be easily removed from the automobile surface by applying a pulling force in a direction away from the vehicle. More particularly, it is an object of the invention to provide a novel training cover that is constructed from a static-cling material that will releasably adhere to the surface of the vehicle.

Another object of the invention is to provide an apparatus of the character described in which the training cover has the general shape of a portion of the hood of a vehicle.

Another object of the invention is to provide an apparatus of the character described in which the training cover has the general shape of a vehicle bumper.

Another object of the invention is to provide a method for teaching installers the proper technique for adhesively bonding a protective covering to an exterior portion of a vehicle, which comprises the steps of first imprinting on an instructional display panel a plurality of instructions defining sequential actions to be taken by the installer in installing the protective covering and a plurality of individual indicia, each individual indicia corresponding to a selected one of the plurality of instructions. The next step in the method of the invention involves the construction of a training cover of the character previously described which has imprinted thereon a plurality of indicia corresponding to the indicia imprinted on the instructional display from a material that will releasably cling to the surface of the automobile. Following positioning of the training cover over a selected portion of the vehicle surface the trainee accomplishes the installation of the training cover by sequentially locating each of the reference indicia that have been imprinted upon the training covering and referring to the instruction imprinted on said training cover that corresponds to the located reference indicia.

These and other objects of the invention will be achieved by the method and apparatus of the invention that is described in greater detail in the paragraphs which follow.

### BRIEF DESCRIPTION OF THE DRAWINGS

FIG. 1 is a generally perspective, exploded diagrammatic view illustrating the manner of placement of a training covering over the hood portion of an automobile.

FIG. 2 is a generally perspective, diagrammatic view similar to FIG. 1 but showing the training covering in place over the hood portion of the automobile.

FIG. 3 is a top plan view of one form of the training covering of the apparatus of the present invention.

FIG. 4 is a generally diagrammatic view of one form of the instructional material of the apparatus of the present invention for use in connection with the training of the installer.

FIG. 5 is a top plan view of an alternate form of the training covering of the apparatus of the invention.

FIG. 6 is a generally perspective, diagrammatic view illustrating an alternate form of training covering in place over the front surface of a conventional bus.

### DESCRIPTION OF THE INVENTION

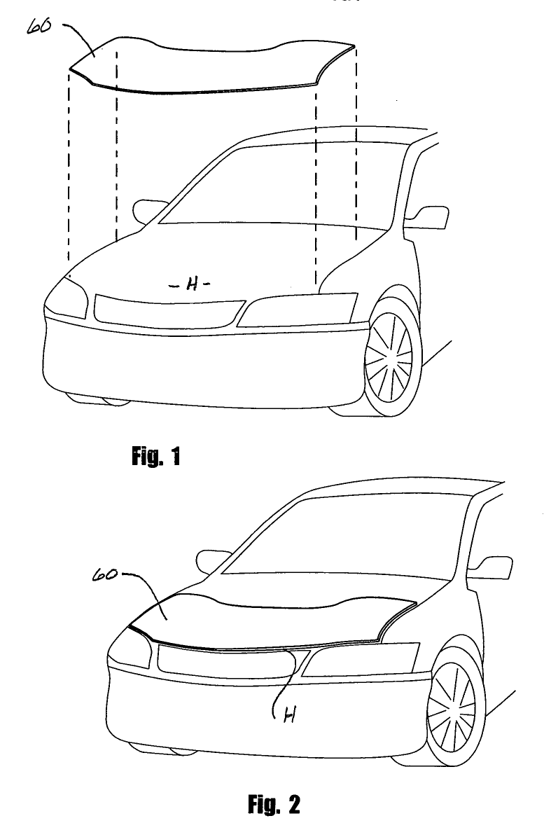

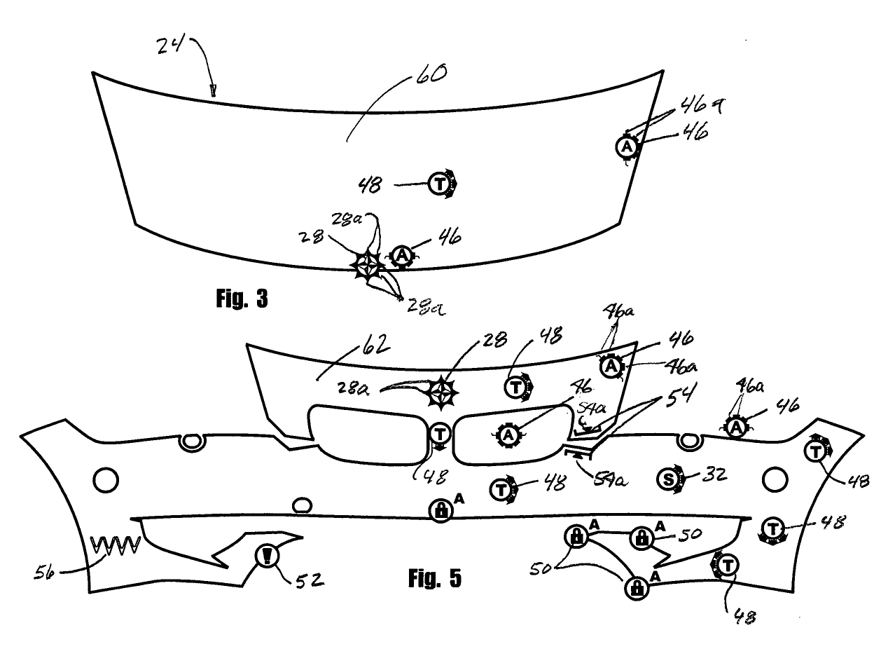

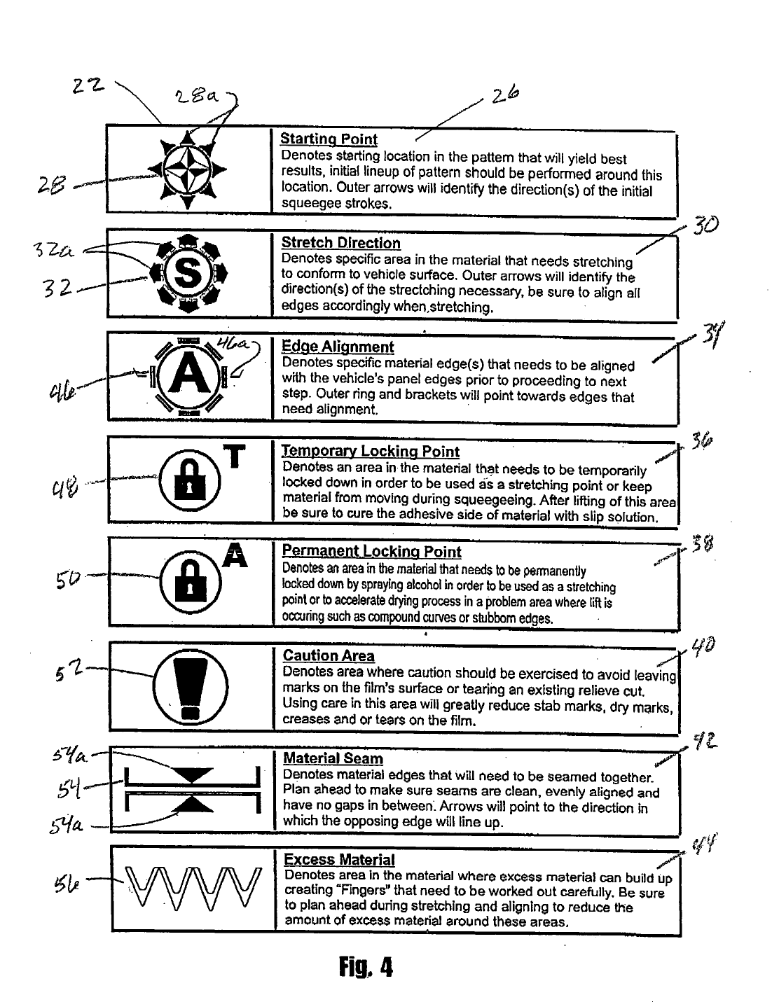

Referring to the drawings, and particularly to FIGS. 1 through 4, one form of the apparatus of the invention is there shown. The apparatus here comprises a plurality of cooperatively associated components that are specially designed for use in training an installer to successfully affix to a surface of the vehicle a protective covering having a shape generally corresponding to the shape of the portion of the vehicle. The principal components of the apparatus comprise a novel instructional display, here shown as a printed poster 22 (FIG. 4), and a training cover 24 (FIG. 3).

As illustrated in FIG. 4, the instructional display 22 comprises a poster constructed from a durable material, such as a plastic sheet having imprinted thereon data comprising a plurality of: instructions and a plurality of indicia corresponding to the instructions. More particularly, the data here comprises a first instruction 26 that concerns the starting point for the installation and a first indicia 28 of unique design that corresponds to the first instruction. The instructional display also includes a second instruction 30 discussing stretch-direction of the training cover and a second indicia 32 of unique design that corresponds to the second instruction. In similar fashion, the instructional display includes third, fourth, fifth, sixth, seventh and eighth instructions 34, 36, 38, 40, 42 and 44 respectively. Each of these instructions provides specific information to the trainee concerning the sequential steps that are to be taken by the trainee to correctly position the training cover unto a portion of the vehicle. Associated with each of the instructions is a uniquely configured indicia identified in FIG. 4 by the numerals 46, 48, 50, 52, 54 and 56 respectively.

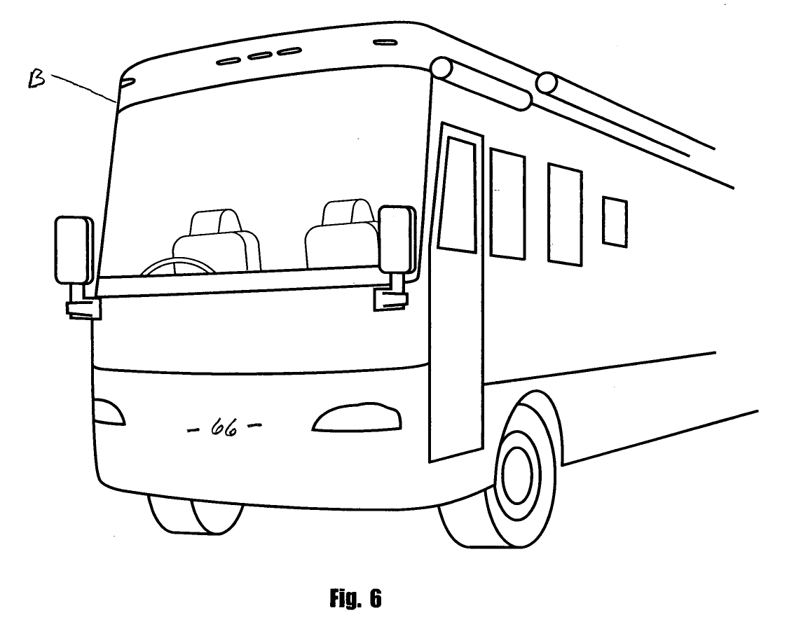

Referring to FIGS. 3 and 5, representative examples of training covers used in the accomplishment of the method of the invention are there shown and generally designated by the numerals 60 and 62. The training cover illustrated in FIG. 3 has a shape generally corresponding to the shape of the forward hood portion “H” of an automobile (see FIGS. 1 and 2). The training cover 62 illustrated in FIG. 5 has a shape substantially corresponding to the shape of the bumper portion of an automobile. As indicated in FIGS. 3 and 5, each of the training covers has imprinted thereon one or more of the reference indicia imprinted on the instructional display 22. More particularly, training cover 60 has imprinted thereon at strategically spaced-apart locations indicia 28, 46 and 48 which correspond to instructions 26, 34 and 36 that appear on the instructional display 22. Similarly training cover 62 has imprinted thereon indicia 28, 32, 46, 48, 50, 52, 54 and 56 which correspond to instructions 26, 30, 34, 36, 38, 40, 42 and 44 that appear on the instructional display 22.

Both of the training covers 60 and 62, as well as the training cover 66, which is used to train installers in the proper technique for installing a protective covering on the front surface of a bus “B”, are constructed from a substantially transparent material that will releasably cling to the surface of the vehicle and one that can be easily removed from the vehicle surface by applying a pulling force in a direction away from the vehicle. While several commercially available materials can be used to construct the training covers, a material offered for sale by the GMI Company of Calabasas Hills, Calif. has proven quite satisfactory.

Considering now the method of the invention for training an installer to successfully install a protective covering onto a vehicle, as previously discussed, because the high cost of producing the protective covering, the considerable time involved in properly installing a protective covering onto a vehicle and the great difficulty involved in properly installing a protective covering, pre-training of the installer is vitally important. In the past, training was typically on a “learn as you go” basis and was accomplished by the trainee attempting to actually install the particular protective covering. Due to the complexity of the installation process and the likelihood of faulty installation by an untrained installer, this approach often proved quite costly. It is this problem that is sought to be solved by the method and apparatus of the present invention, which allows training of the installer using a much less expensive training covering and one which can be used repeatedly.

In accordance with one form of the method of the present invention for training an installer to successfully install a protective covering onto a vehicle, the first step in the method involves the preparation of an instructional display of the character illustrated in FIG. 4 of the drawings. This step is accomplished by imprinting on a display panel in a conventional manner a plurality of instructions defining sequential actions to be taken by the installer in installing the protective covering and a plurality of individual indicia, each individual indicia corresponding to a selected one of the plurality of instructions.

The next step in the method of the invention involves the construction of a training cover from a material that will releasably cling to the surface of the automobile. The training covering has a shape substantially identical to the shape of the protective covering that is later to be installed and has printed thereon a plurality of reference indicia, each reference indicia corresponding to a selected one of the plurality of individual indicia imprinted on the instructional display.

Following the appropriate cleaning and drying of the vehicle, and following a careful study of the display panel, the trainee installer carefully places the training cover over the selected area of the vehicle. This done, the trainee sequentially locates each of the reference indicia that have been imprinted upon said training covering and refers to the instruction imprinted. on said training cover that corresponds to the located reference indicia. More particularly, by locating on the training cover the symbol, or indicia 28, the trainee can determine the starting location on the pattern that will yield the best results for the training installation. As provided in the instructional material 26, the training cover is thusly initially lined up in a manner such that installation is performed around this location. The outer arrows 28a formed on the indicia 28 identify the directions of the initial squeegee strokes that are to be performed by the trainee.

Next, the trainee locates on the training cover the indicia 32 which denotes the specific areas in the material that require stretching so as to properly conform to the vehicle surface (FIG. 5). Once again, the outer arrows 32a of the indicia 32 indicate the directions of the necessary stretching of the training cover. Prior to accomplishing the stretching step, the trainee locates on the training cover the indicia 46 which denotes the specific material edges that are required to be aligned with the vehicle panel edges prior to proceeding to the next step. In this regard, the brackets 46a provided on the indicia 46 point toward the edges that require alignment. Also prior to accomplishing the training step, the trainee locates on the training cover the indicia 48 which denote the areas in the material that need to be temporary locked down for use as a stretching point. Additionally, the trainee locates the indicia 50 that identify the areas that need to be permanently locked down by spraying alcohol on the area in order that the area can be used as a stretching point or as a location to accelerate the drying process.

During the accomplishment of the installation process the trainee locates on the training cover the indicia 52 which denote areas where caution should be exercised to avoid leaving marks on the film surface and to avoid tearing of an existing relief cut in the covering. Additionally, by locating the indicia 54 on the training cover, the trainee can identify material edges that need to be seamed together. This enables the trainee to plan ahead to make certain that seams are clean, evenly aligned and have no gaps therebetween. The arrows 54a, which comprise a part of the indicia 54, indicate the directions in which the opposing edges will line up. Finally, by locating the indicia 56 on the training cover, the trainee can identify the areas in which the material excess can build up in a manner to create undesirable “fingers” that need to be carefully worked out.

After the trainee has completed installation of the training cover in accordance with the instructions set forth on the instructional display, the trainee supervisor inspects the installed training cover and points out to the trainee any errors that have been made during the training process as, for example, wrinkles or creases in the training cover, misaligned edges and the like. Following this review step with the trainee, the training cover is removed from the vehicle by applying a pulling force in a direction away from the vehicle. Due to the static-cling feature of the training cover, the cover can be removed from the vehicle a number of times and reused by the trainee or by other trainees. Through repeated training sessions in accordance with the methods set forth in the preceding paragraphs, the proficiency of the trainee can be continually improved until the trainee is capable of the proper installation of the more expensive protective covering that will remain on the vehicle.

Having now described the invention in detail in accordance with the requirements of the patent statutes, those skilled in this art will have no difficulty in making changes and modifications in the individual parts or their relative assembly in order to meet specific requirements or conditions. Such changes and modifications may be made without departing from the scope and spirit of the invention, as set forth in the following claims.

I claim:

1. A method for training an installer to successfully install a protective covering onto a vehicle, said protective covering having a shape generally corresponding to the shape of a portion of the vehicle, said method comprising the steps of:
(a) preparing an instructional display by imprinting thereon a plurality of instructions defining sequential actions to be taken by the installer in installing the protective covering;
(b) imprinting on said instructional display a plurality of individual indicia, each individual indicia corresponding to a selected one of said plurality of instructions;
(c) constructing a training cover from a material that will releasably cling to the surface of the automobile, said training covering having a shape substantially identical to the shape of said protective covering and having imprinted thereon a plurality of reference indicia, each reference indicia corresponding to a selected one of said plurality of individual indicia imprinted on said instructional display;
(d) placing said training cover unto the vehicle; and
(e) sequentially locating each said reference indicia imprinted upon said training covering, referring to said instruction imprinted on said training cover corresponding to said located reference indicia display and following said instruction to partially affix said training covering to the automobile.

2. The method as defined in claim 1, including the further step of removing said training cover from the automobile, replacing said training cover on the automobile and sequentially locating each said reference indicia imprinted upon said training covering, referring to said instruction imprinted on said training cover corresponding to said located reference indicia display and following said instruction to partially affix said training covering to the automobile.

3. A method for training and the installer to successfully install a protective covering onto a vehicle, said protective covering having a shape generally corresponding to the shape of a portion of the vehicle, said method comprising the steps of:
(a) preparing an instructional display comprising:
(i) a first instruction;
(ii) a first indicia corresponding to said first instruction;
(iii) a second instruction;
(iv) an indicia corresponding to said second instruction;
(b) constructing a training cover from a material that will releasably cling to the surface of the automobile, said training covering having a shape substantially identical to the shape of said protective covering and having printed thereon a first reference indicia corresponding to said first indicia of said instructional display and having printed thereon a second reference indicia corresponding to said second indicia of said instructional display;
(c) placing said training cover unto the vehicle;
(d) locating said first reference indicia, referring to said first instruction of said instructional display and following said first instruction to partially affix said training covering to the automobile; and
(e) locating said second reference indicia, referring to said second instruction of said instructional display and the following said second instruction to partially affix said training cover to the automobile.

4. The method as defined in claim 3 in which said instructional display further comprises a third instruction and a third indicia corresponding to said third instruction, said method comprising the further steps of locating said third reference indicia, referring to said third instruction of said instructional display and following said third instruction further partially affixing said training covering to the automobile.

5. An apparatus for use in training an installer to successfully affix to a surface of the vehicle a protective covering having a shape generally corresponding to the shape of the portion of the vehicle, said apparatus comprising:
(a) an instructional display comprising:
(i) a first instruction;
(ii) a first indicia corresponding to said first instruction;
(iii) a second instruction; and
(iv) a second indicia corresponding to said second instruction; and
(b) a training cover having a shape substantially corresponding to the shape of the protective covering, said training cover having a first reference indicia imprinted thereon corresponding to said first indicia imprinted on said instructional display and a second reference indicia imprinted thereon corresponding to said second indicia imprinted on said instructional display.

6. The apparatus as defined in claim 5 in which said training cover is constructed from a material that will releasably cling to the surface of the automobile.

7. The apparatus as defined in claim 5 in which said training cover is constructed from a material that can be easily removed from the automobile surface by applying a pulling force in a direction away from the vehicle.

8. The apparatus as defined in claim 7 in which said protective covering has the general shape of a portion of the hood of the vehicle and in which said training cover has the general shape of a portion of the hood of the vehicle.

9. The apparatus as defined in claim 7 in which said protective covering has the general shape of a portion of the bumper of the vehicle and in which said training cover has the general shape of a portion of the bumper of the vehicle.

10. An apparatus for use in training an installer to successfully affix to a surface of the vehicle a protective covering having a shape generally corresponding to the shape of the portion of the vehicle, said apparatus comprising:
(a) an instructional display comprising:
(i) a first instruction;
(ii) a first indicia corresponding to said first instruction;
(iii) a second instruction; and
(iv) a second indicia corresponding to said second instruction;
(v) a third instruction;
(vi) a third indicia corresponding to said third instruction
(b) a training cover having a shape substantially corresponding to the shape of the protective covering and being constructed from a material that will releasably cling to the surface of the automobile, said training cover having a first reference indicia imprinted thereon corresponding to said first indicia imprinted on said instructional display, a second reference indicia imprinted thereon corresponding to said second indicia imprinted on said instructional display and a third reference indicia imprinted thereon corresponding to said third indicia imprinted on said instructional display.

11. The apparatus as defined in claim 10 in which said training cover is constructed from a static-cling material.

12. The apparatus as defined in claim 10 in which the vehicle comprises an automobile and in which said protective covering has the general shape of a portion of the hood of the automobile and in which said training cover has the general shape of a portion of the hood of the automobile.

13. The apparatus as defined in claim 10 in which said protective covering has the general shape of a portion of the bumper of the vehicle and in which said training cover has the general shape of a portion of the bumper of the vehicle.

14. The apparatus as defined and claim 10 in which the vehicle comprises a bus and in which said protective covering has the general shape of a portion of the front surface of the bus and in which said training cover has the general shape of a portion of the front surface of the bus.

15. The apparatus as defined in claim 10 in which said protective covering is substantially transparent.
